(19) United States
(12) Patent Application Publication
(10) Pub. No.: US 2017/0195976 A1
(43) Pub. Date: Jul. 6, 2017

(54) TERMINAL APPARATUS

(71) Applicant: Sharp Kabushiki Kaisha, Sakai City, Osaka (JP)

(72) Inventors: Jungo GOTO, Sakai City (JP); Osamu NAKAMURA, Sakai City (JP); Daiichiro NAKASHIMA, Sakai City (JP); Yasuhiro HAMAGUCHI, Sakai City (JP)

(73) Assignee: Sharp Kabushiki Kaisha, Sakai City, Osaka (JP)

(21) Appl. No.: 15/317,549

(22) PCT Filed: May 29, 2015
(86) PCT No.: PCT/JP2015/065508

§ 371 Date: Dec. 9, 2016

(30) Foreign Application Priority Data
Jun. 11, 2014 (JP) 2014-120935

(51) Int. Cl. H04W 52/32; H04W 52/44

(52) U.S. Cl. CPC H04W 52/325; H04W 52/44

(57) ABSTRACT

A terminal apparatus that can efficiently assign transmitting power is provided. The terminal apparatus terminal apparatus that performs communication with a plurality of cells simultaneously includes a control signal processor that receives a control signal providing a notification indicating that at least one of the plurality of cells is to enter an off state in which data communication is not performed temporarily, and a transmitting power controller that, in a case where transmitting power of each of the plurality of connected cells is determined and in a case where a value of a total of the transmitting power needed for the plurality of cells is judged to exceed maximum transmitting power of the terminal apparatus, refers to content of the notification provided by the control signal and judges priority in assigning transmitting power to a channel and a signal that are transmitted in each of the plurality of connected cells. The transmitting power controller gives the priority in assigning power to a sounding reference signal to be transmitted in at least one of the cells that is not in the off state over a sounding reference signal to be transmitted in the one cell in the off state.

### TECHNICAL FIELD

The present invention relates to a transmitting power control method for a terminal apparatus.

### BACKGROUND ART

In 3GPP (The 3rd Generation Partnership Project), LTE (Long Term Evolution)-Advanced (hereinafter, referred to as LTE-A) has been specified as a standard specification for mobile communication. In LTE-A, carrier aggregation is employed. In carrier aggregation, a terminal apparatus regards a cell as a component carrier (also referred to as a serving cell), gathers a plurality of cells, and performs communication.

NPL 1, which contributed to 3GPP, proposes a notification to a terminal apparatus connected to a plurality of component carriers to which the carrier aggregation is applied. The notification indicates whether the individual component carriers are in a state where data communication is allowed (in an on state or an off state).

### CITATION LIST

### Non Patent Literature

NPL 1: Qualcomm Incorporated, “Small cell on/off time reduction”, 3GPP TSG-RAN WG1 #76 R1-140452, Feb. 10th-14th 2014

### SUMMARY OF INVENTION

### Technical Problem

A problem is that a mobile communication system capable of performing switching between on and off states of cells does not efficiently assign the cells transmitting power in a mobile-station apparatus.

For example, to date, priority has been given to an uplink control channel (Physical Uplink Control Channel; PUCCH) in assigning transmitting power. However, since transmitted information might not be used in the uplink control channel in a cell in the off state, the transmitting power might be unnecessarily assigned despite the given priority.

The present invention has been made under these circumstances and provides a terminal apparatus and a transmitting power control method that can efficiently assign transmitting power.

### Solution to Problem

(1) The present invention has been made to solve the aforementioned problem. According to an aspect of the present invention, the present invention provides a terminal apparatus that is connected to a plurality of cells simultaneously and that performs communication by using the plurality of cells. The terminal apparatus includes a control signal processor that receives a control signal providing a notification indicating that at least one of the plurality of cells is to enter an off state in which data communication is not performed temporarily, and a transmitting power controller that, in a case where transmitting power of each of the plurality of connected cells is determined and in a case where a value of a total of the transmitting power needed for the plurality of cells is judged to exceed maximum transmitting power of the terminal apparatus, refers to content of the notification provided by the control signal and judges priority in assigning transmitting power to a channel and a signal that are transmitted in each of the plurality of connected cells. The transmitting power controller gives the priority in assigning power to a sounding reference signal to be transmitted in at least one of the cells that is not in the off state over a sounding reference signal to be transmitted in the one cell in the off state.

(2) According to another aspect of the present invention, in the terminal apparatus according to (1), the transmitting power controller gives the priority in assigning the power to the sounding reference signal to be transmitted in the cell not in the off state over a control channel to be transmitted in the one cell in the off state.

(3) According to another aspect of the present invention, in the terminal apparatus according to (1), the transmitting power controller gives the priority in assigning the power to a shared channel or a control channel to be transmitted in the cell not in the off state over to the sounding reference signal to be transmitted in the one cell in the off state.

(4) According to another aspect of the present invention, in the terminal apparatus according to (1), the control signal processor receives the control signal from the cell not in the off state. The control signal provides the notification indicating that the at least one cell is to enter the off state in which the data communication is not performed temporarily.

(5) According to another aspect of the present invention, in the terminal apparatus according to (1), the notification received by the control signal processor includes at least one of pieces of information regarding a transmission cycle, a used resource element, an antenna port, a signal sequence, and a cell ID used for signal generation. The notification indicates that the at least one cell is to enter the off state in which the data communication is not performed temporarily.

### Advantageous Effects of Invention

According to the present invention, the transmitting power can be efficiently assigned.

### BRIEF DESCRIPTION OF DRAWINGS

FIG. 1 is a schematic block diagram illustrating the configuration of a mobile communication system according to a first embodiment of the present invention.

FIG. 2 is a sequence diagram illustrating example operation of the mobile communication system according to this embodiment.

FIG. 3 is a schematic block diagram illustrating the configuration of a mobile-station apparatus 13 according to this embodiment.

FIG. 4 is a time chart illustrating an example of changes between on and off states according to this embodiment.

FIG. 5 is a flowchart explaining operation of a transmitting power controller 304 according to this embodiment.

FIG. 6 is a flowchart explaining operation of the transmitting power controller 304 according to a second embodiment of the present invention.

FIG. 7 is a flowchart explaining operation of the transmitting power controller 304 according to a third embodiment of the present invention.

FIG. 8 is a flowchart explaining operation of the transmitting power controller 304 according to a modification of the third embodiment of the present invention.

FIG. 9 is a flowchart explaining operation of the transmitting power controller 304 according to a fourth embodiment of the present invention.

### DESCRIPTION OF EMBODIMENTS

### First Embodiment

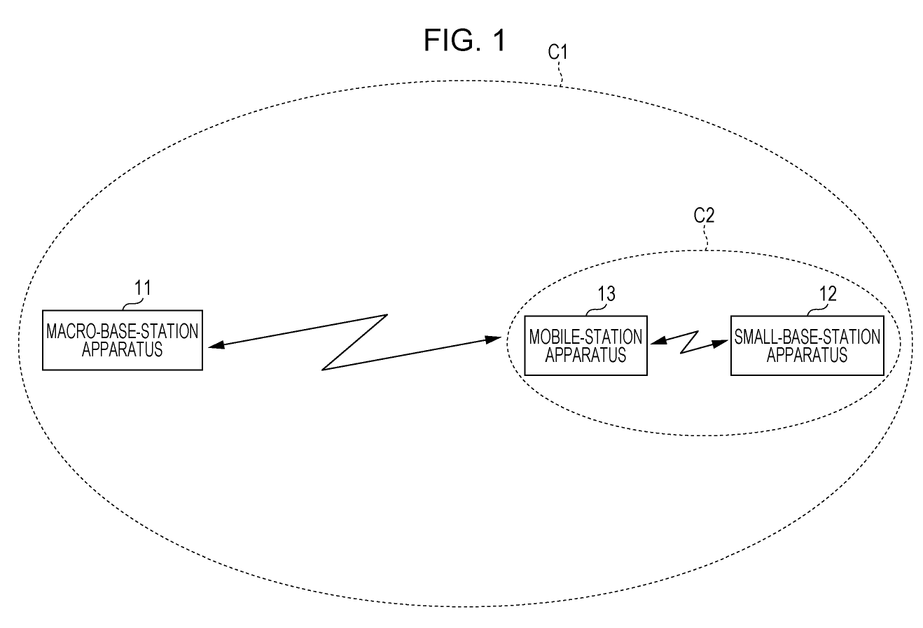

Hereinafter, a first embodiment of the invention will be described with reference to the drawings. FIG. 1 is a schematic block diagram illustrating the configuration of a mobile communication system according to the first embodiment of the invention. The mobile communication system according to this embodiment includes a macro-base-station apparatus 11, a small-base-station apparatus 12, and a mobile-station apparatus 13 (also referred to as a terminal apparatus or UE (User Equipment)). The macro-base-station apparatus 11 forms a cell C1 and performs radio communication with the mobile-station apparatus 13. The small-base-station apparatus 12 forms a cell C2 in such a manner that the communication range thereof is within or partially overlaps that of the cell C1 and performs radio communication with the mobile-station apparatus 13. The mobile-station apparatus 13 performs carrier aggregation with the cell C1 serving as a primary cell (PCell) and the cell C2 serving as a secondary cell (SCell) and performs the radio communication by using the cells C1 and C2 simultaneously. Note that this embodiment will be described on the assumption that the on and off states are switched only in the secondary cell. The primary cell does not have to be a cell of the macro-base-station apparatus and may be a small cell in which the on and off states are not switched.

Note that the cells aggregated in the carrier aggregation are composed of one primary cell serving as a base and one or more secondary cells added thereto. The cell C2 in this embodiment is the secondary cell but includes an uplink used for transmission from a mobile station to a base station. That is, the cells C1 and C2 each include a downlink used for transmission from the base station to the mobile station, and the uplink. The cells C1 and C2 in this embodiment use TDD (Time Division Duplex) but may use a FDD (Frequency Division Duplex) scheme.

Although the frequency bands of the cells C1 and C2 differ from each other, the cells C1 and C2 may belong to the same band (such as a 800 MHz band or a 2 GHz band) or may belong to different bands. Note that carrier aggregation performed by aggregating a plurality of cells belonging to the same band is referred to as intra-band carrier aggregation, and carrier aggregation performed by aggregating a plurality of cells belonging to different bands is referred to as inter-band carrier aggregation.

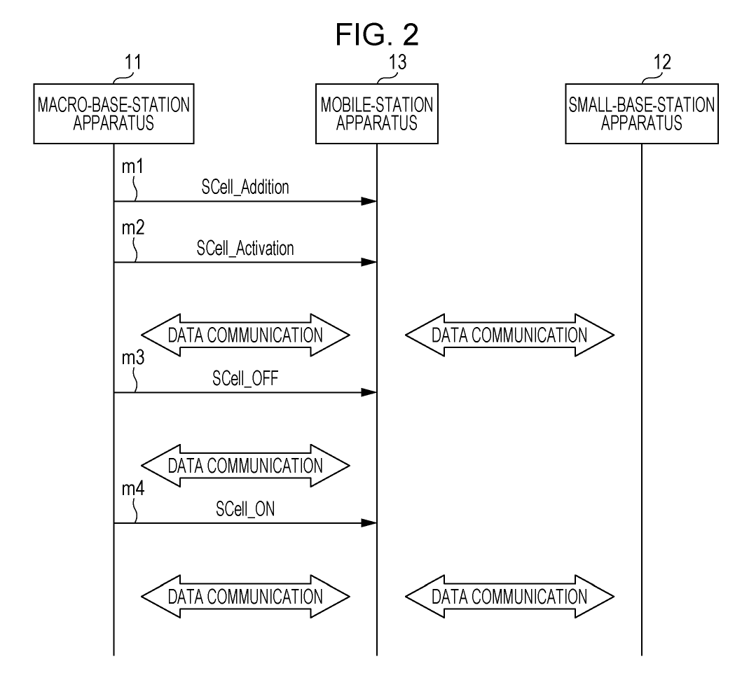

FIG. 2 is a sequence diagram illustrating example operation of the mobile communication system according to this embodiment. In the sequence diagram in FIG. 2, in an initial state, the mobile-station apparatus 13 performs data communication with the macro-base-station apparatus 11 but does not perform radio communication with the small-base-station apparatus 12. That is, the mobile-station apparatus 13 does not perform carrier aggregation. The phrase “performing data communication” denotes transmitting data (user data) to the mobile-station apparatus 13 by using a downlink shared channel (Physical Downlink Shared Channel; PDSCH) or transmitting data from the mobile-station apparatus 13 by using an uplink shared channel (Physical Downlink Shared Channel).

Assume a case where, at this time, the traffic increases between the macro-base-station apparatus 11 and the mobile-station apparatus 13, a case where a cell allowing favorable quality communication is detected based on a RRM (Radio Resource Management) measurement of a neighboring cell, or another case. In such a case, the macro-base-station apparatus 11 notifies the mobile-station apparatus 13 of an instruction m1 (SCell_Addition) for adding the cell C2 of the small-base-station apparatus 12 as a secondary cell. In the instruction m1, for example, an index indicating the cell C2 is included in sCellToAddModList in RRC (Radio Resource Control) signaling.

The mobile-station apparatus 13 having received the instruction m1 for adding the cell C2 performs carrier aggregation by using the cell C1 of the macro-base-station apparatus 11 as the primary cell and the cell C2 of the small-base-station apparatus 12 as the secondary cell. However, since simply receiving the instruction m1 for adding the cell C2 does not cause the cell C2 to be activated, a sounding reference signal (Sounding Reference Symbol; SRS) is not transmitted in the cell C2, CQI/PMI/RI/PTI regarding the cell C2 is not reported, a downlink control channel (Physical Downlink Control Channel; PDCCH) is not monitored in the cell C2, and the downlink control channel is not monitored regarding the cell C2.

The macro-base-station apparatus 11 notifies the mobile-station apparatus 13 of an instruction m2 (SCell_Activation) for activating the cell C2. The instruction m2 for activating the cell C2 is an instruction in which, for example, a bit corresponding to the cell C2 in an Activation/Deactivation Mac Control Element in MAC (Mediaum Access Control) signaling is set to 1. The mobile-station apparatus 13 having received the instruction m2 for activating the cell C2 starts transmitting the sounding reference signal in the cell C2, reporting CQI/PMI/RI/PTI regarding the cell C2, monitoring the downlink control channel in the cell C2, and monitoring the downlink control channel regarding the cell C2. The mobile-station apparatus 13 thereby performs data communication using the cell C1 with the macro-base-station apparatus 11 and data communication using the cell C2 with the small-base-station apparatus 12.

If the traffic decreases, the macro-base-station apparatus 11 determines that the small-base-station apparatus 12 is to enter an off state. The macro-base-station apparatus 11 transmits, to the mobile-station apparatus 13, a notification m3 (SCell_OFF) instructing the small-base-station apparatus 12 about the off state and causing the cell C2 to enter the off state. The phrase “an off state of a cell” denotes the following state of the small-base-station apparatus 12. The small-base-station apparatus 12 temporarily does not perform data communication with any mobile station in a cell activated as a secondary cell, but to enable rapid recovery to the on state, still transmits a DRS (Discovery Reference Signal) through the downlink and receives the sounding reference signal, CQI, and the like through the uplink. Note that the DRS is a signal transmitted regardless of whether the small cell is in the on state or the off state or is a signal transmitted only in the off state. Accordingly, upon receiving the notification m3, the mobile-station apparatus 13 performs data communication using the cell C1 with the macro-base-station apparatus 11 but does not perform data communication using the cell C2 with the small-base-station apparatus 12.

The notification m3 causing the off state may be provided, for example, in DCI (Downlink Control Information) format 1C (see 3GPP TS36.212) for a downlink control channel by using a RNTI (Radio Network Temporary Identifier) for notifying the off state, may be provided in another DCI format for a downlink control channel, or may be provided using the MAC signaling. The notification m3 causing the off state is a bit string composed of at least one bit. For example, among cells on which the mobile-station apparatus 13 performs carrier aggregation, the bit corresponds to a cell (that is, a secondary cell) likely to undergo switching between the on and off states. If the cell is in the on state, the bit is set to “1”. If the cell is to enter the off state, the bit is set to “0”. Alternatively, the notification m3 causing the off state may be composed of bits indicating a cell ID (a physical ID, a virtual ID, or another ID identifying the small cell) or the like and indicating the on or off state of the cell assigned the cell ID or switching between the on and off states. To rapidly perform switching between the on and off states, the notification m3 may be desirably provided using the aforementioned downlink control channel or L1 (Layer 1) signaling such as the MAC signaling but may be provided by using a method other than the L1 signaling, such as the RRC signaling. Note that the switching between the on and off state is performed in the activated cell in the description above but may be performed in a deactivated cell.

Note that even if the cell C2 is in the off state, the mobile-station apparatus 13 receives a reference signal through the downlink of the cell C2, transmits a sounding reference signal through the uplink, and transmits an uplink control channel. The mobile-station apparatus 13 does not perform data communication in the off state and thus does not monitor control information for PDSCH resource allocation and control information for PUSCH resource allocation in the downlink control channel for the cell C2 in the off state.

In addition, the DRS in the downlink in the off state may be a Cell Specific Reference Signal (CRS) and may be a Channel State Information Reference Signal (CSI-RS), and the CRS and the CSI-RS may each have a long transmission cycle. Resource elements used for the on state, an antenna port, and transmission may be differently configured. A signal sequence thereof may be generated as a sequence different from that for the on state and may be another reference signal. In addition, a signal transmitted through the downlink in the off state may include a PSS (Primary Synchronization signal) or a SSS (Secondary Synchronization signal), and the PSS and the SSS may each have a long transmission cycle. The notification m3 causing the off state may be provided to the mobile-station apparatus 13 by using a different setting (for example, at least one of a transmission cycle, a used resource element, an antenna port, a signal sequence, and a cell ID used for generating a signal) for reference signals to be respectively transmitted in the on state and the off state, instead of the bit indicating the on or off state.

Subsequently, if the traffic increases again, the macro-base-station apparatus 11 determines that the small-base-station apparatus 12 is to return to the on state. The macro-base-station apparatus 11 transmits, to the mobile-station apparatus 13, a notification m4 (SCell_ON) instructing the small-base-station apparatus 12 about the on state and causing the cell C2 to enter the on state. The notification m4 causing the on state is provided in the same manner as for the notification m3 causing the off state. After receiving the notification m4, the mobile-station apparatus 13 performs data communication using the cell C2 with the small-base-station apparatus 12 and data communication using the cell C1 with the macro-base-station apparatus 11.

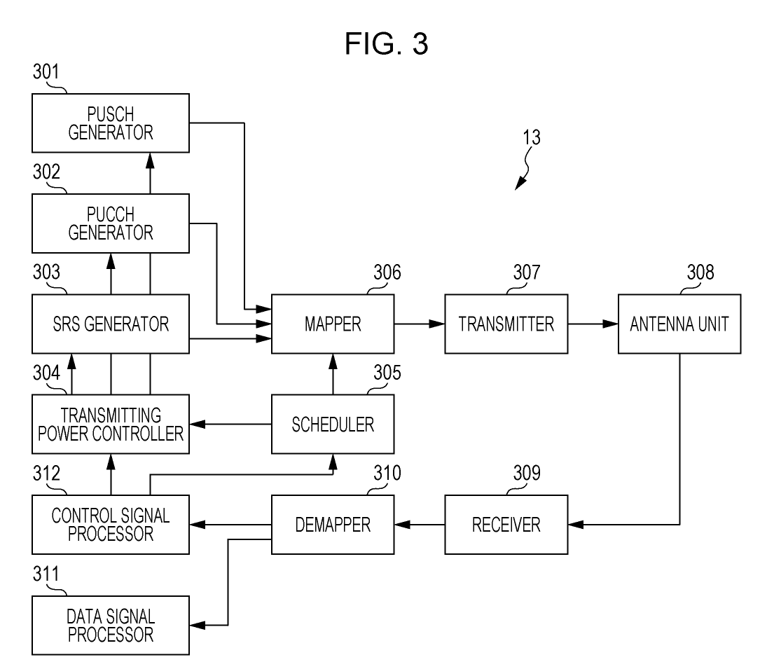

FIG. 3 is a schematic block diagram illustrating the configuration of the mobile-station apparatus 13. The mobile-station apparatus 13 includes a PUSCH generator 301, a PUCCH generator 302, a SRS generator 303, the transmitting power controller 304, a scheduler 305, a mapper 306, a transmitter 307, an antenna unit 308, a receiver 309, a demapper 310, a data signal processor 311, and a control signal processor 312.

The PUSCH generator 301 generates an uplink shared channel (Physical Uplink Shared Channel; PUSCH) signal. The signal generated by the PUSCH generator 301 is a frequency domain signal for uplink resource element allocation. Note that a resource element is a minimum unit of radio resources each defined by subcarrier No. and OFDM symbol No. The PUSCH generator 301 generates the signal for the uplink shared channel so that a mean amplitude of the signal can be an amplitude corresponding to transmitting power designated by the transmitting power controller 304. For example, the PUSCH generator 301 in advance stores therein a lookup table for associating transmitting power per subcarrier with a coefficient used for symbol value multiplication. The PUSCH generator 301 reads, from the lookup table, a coefficient associated with a value obtained by dividing the transmitting power designated by the transmitting power controller 304 by the number of subcarriers in the uplink shared channel and multiplies each of frequency spectra of the uplink shared channel by the coefficient.

Note that the uplink shared channel is a channel for transmitting control signals such as aperiodic CSI (Channel State Information), the RRC signaling, and the MAC signaling, data, and the like. Note that CSI includes a CQI (Channel Quality Indicator), a PMI (Precoding Matrix Indicator), a PTI (Precoding Type Indicator), a RI (Rank Indicator), and the like.

The PUCCH generator 302 generates an uplink control channel (Physical Uplink Control Channel; PUCCH) signal. The signal generated by the PUCCH generator 302 is a frequency domain signal for uplink resource element allocation. Like the PUSCH generator 301, the PUCCH generator 302 generates the signal for the uplink control channel so that a mean amplitude of the signal can be an amplitude corresponding to transmitting power designated by the transmitting power controller 304. Note that the uplink control channel is a channel for transmitting ACK/NACK, periodic CSI (Channel State Information), a SR (Scheduling Request), and the like for the downlink shared channel (Physical Downlink Shared Channel; PDSCH).

The SRS generator 303 generates a sounding reference signal. The signal generated by the SRS generator 303 is a frequency domain signal for uplink resource element allocation. Like the PUSCH generator 301, the SRS generator 303 generates the sounding reference signal so that a mean amplitude of the signal can be an amplitude corresponding to transmitting power designated by the transmitting power controller 304.

The transmitting power controller 304 determines, for each subframe, the transmitting power of the channels and the reference signal that are to be transmitted by the mobile-station apparatus 13 in each cell and notifies the PUSCH generator 301, the PUCCH generator 302, and the SRS generator 303 of the transmitting power. When determining the transmitting power, the transmitting power controller 304 refers to the allocation for the channels (PUSCH and PUCCH) and the reference signal (SRS) in each cell and also refers to the notifications (notifications m3 and m4 in FIG. 2) each indicating the on or off state of the secondary cell. The allocation has been determined by the scheduler 305, and the notifications have undergone receiving processes performed by the control signal processor 312. The details of how the transmitting power controller 304 determines the transmitting power will be described later.

The scheduler 305 determines, for each subframe, the allocation for the channels (PUSCH and PUCCH) and the reference signal (SRS) in each cell. The scheduler 305 determines, for example, the uplink shared channel allocation on the basis of resource allocation information notified through the downlink control channel. Note that the mobile-station apparatus 13 according to this embodiment supports transmission of the uplink control channel in not only the cell C1 that is the PCell but also the cell C2 that is the SCell. The mapper 306 allocates the signals generated by the PUSCH generator 301, the PUCCH generator 302, and the SRS generator 303 to the resource elements in each cell in accordance with the determination by the scheduler 305 and thereby configures each frequency domain signal with subframes in the corresponding cell.

After performing, for each cell, the inverse Fast Fourier transform on the frequency domain signal configured by the mapper 306, the transmitter 307 adds a Guard Interval to the signal, and thereby generates a time domain signal for each cell. The transmitter 307 generates a radio transmission signal by performing digital-to-analog conversion, upconversion to a radio frequency signal, and other processes on the time domain signal for each cell and wirelessly transmits the signal through the antenna unit 308. Note that in a case where the frequency bands of the cells are close to each other, the transmitter 307 may collectively perform the inverse Fast Fourier transform on the frequency domain signals in the cells, add a Guard Interval to each signal, and generate a time domain signal for the cells collectively.

The antenna unit 308 includes one or more antennas for performing the radio communication in the cells. Note that an antenna for performing the radio communication in the cell C1 may be the same as or be different from an antenna for performing the radio communication in the cell C2.

The receiver 309 performs downconversion to a baseband frequency signal, analog-to-digital conversion, and other processes on the radio reception signal received in each cell through the antenna unit 308 and obtains a time domain signal including a Guard Interval. The receiver 309 removes the Guard Interval from the time domain signal, performs the Fast Fourier transform thereon, and thereafter acquires a frequency domain signal.

The demapper 310 extracts a control signal for the mobile-station apparatus and a data signal for the mobile-station apparatus from the frequency domain signal acquired by the receiver 309 for each cell and inputs the signals into the control signal processor 312 and the data signal processor 311, respectively. Note that the control signal includes the RRC signaling, the MAC signaling, and the like that are transmitted through the downlink control channel (Physical Downlink Control Channel; PDCCH) and the downlink shared channel (Physical Downlink Shared Channel; PDSCH). The data signal is transmitted through the physical downlink shared channel.

The data signal processor 311 performs receiving processes such as demodulation and decoding on the data signals input from the demapper 310 and thereby reconstructs data transmitted from the macro-base-station apparatus 11 and the small-base-station apparatus 12. The control signal processor 312 performs receiving processes such as demodulation and decoding on the control signals input from the demapper 310 and thereby reconstructs control signals transmitted from the macro-base-station apparatus 11 and the small-base-station apparatus 12. The control signal processor 312 inputs, into the scheduler 305, information regarding scheduling of the channels and the reference signals among the reconstructed control signals. The control signal processor 312 also inputs, into the transmitting power controller 304, information regarding the transmitting power for the channels and the reference signals among the reconstructed control signals.

Note that the information regarding scheduling includes radio resource allocation for the uplink shared channel, the transmission cycle and offset of CSI, the transmission cycle and offset of a SRS, and the like. The information regarding transmitting power includes a notification of the on or off state of the secondary cell.

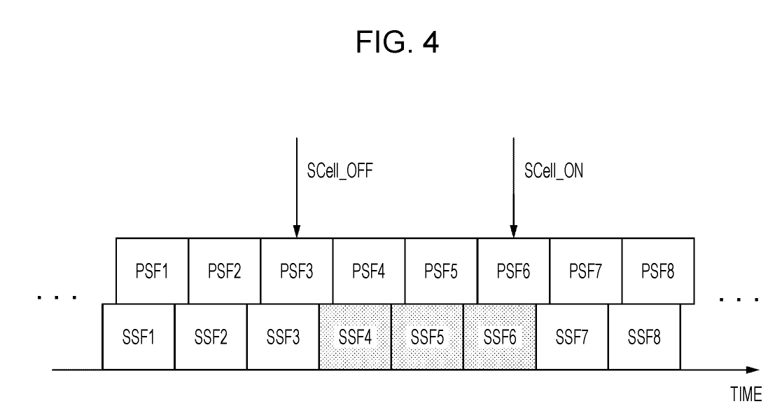

FIG. 4 is a time chart illustrating an example of changes between the on and off states. In FIG. 4, the horizontal axis represents time. Subframes PSF1, PSF2, . . . and PSF8 are subframes of the cell C1 serving as the primary cell. Subframes SSF1, SSF2, . . . and SSF8 are subframes of the cell C2 serving as the secondary cell. In FIG. 4, the subframes PSF1 and SSF1 are subframes of the uplink. The subsequent subframes PSF2, SSF2, PSF3, and SSF3 are subframes of the downlink. The subsequent subframes PSF4 and SSF4 are subframes each partially included in the downlink and the uplink. The subsequent subframes PSF5, SSF5, PSF6, and SSF6 are subframes of the uplink. The subsequent subframes PSF7, SSF7, PSF6, and SSF6 are subframes of the uplink.

As illustrated in FIG. 4, timeframes of the cell C1 subframes and those of the cell C2 subframes do not necessarily completely match. However, if one of the cell C1 subframes and one of the cell C2 subframes have the same subframe No., the subframes are considered to be in the same timeframe. For example, in FIG. 4, the subframe SSF1 and the subframe PSF1 have the same subframe No.

In the example in FIG. 4, a notification SCell_OFF causing the cell C2 to be in the off state is transmitted in the subframe PSF3 of the downlink. The transmitting power controller 304 of the mobile-station apparatus 13 receiving the notification SCell_OFF considers the subframe SSF4 of the cell C2 and the subframes subsequent to the subframe SSF4 to be in the off state and controls the transmitting power of the cells, the subframe SSF4 being subsequent to the subframe PSF3 in which the notification SCell_OFF is received.

In the example in FIG. 4, a notification SCell_ON causing the cell C2 to be in the on state is transmitted in the subframe PSF7 of the downlink. The transmitting power controller 304 of the mobile-station apparatus 13 receiving the notification SCell_ON considers the subframe SSF8 of the cell C2 and subframes subsequent to the subframe SSF8 to be in the on state and controls the transmitting power of the cells, the subframe SSF8 being subsequent to the subframe PSF7 in which the notification SCell_ON is received.

Note that the notifications SCell_OFF and SCell_ON are transmitted in the subframes of the downlink because the mobile communication system according to this embodiment uses time division duplexing but can be transmitted in any frame if frequency division duplexing is used. In addition, although the case where the cell enters the off state in the subframe subsequent to the subframe in which the notification SCell_OFF is transmitted has been described, a trigger for the off state is not limited thereto. For example, the subframe No. of a subframe to enter the off state may be included in the notification SCell_OFF, and the off state may be started in a subframe a predetermined number of subframes after a subframe in which the notification SCell_OFF is transmitted. The same holds true for the notification SCell_ON.

In addition, if a cell C1 subframe and a cell C2 subframe have the same subframe No., the uplink and the downlink may be reversed with respect each other in the subframes.

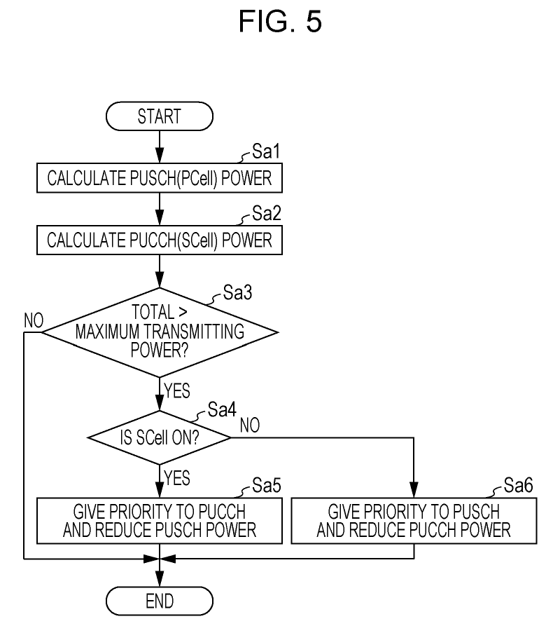

FIG. 5 is a flowchart explaining operation of the transmitting power controller 304. The flowchart in FIG. 5 illustrates a process performed at the time of controlling the transmitting power of subframes for respectively transmitting an uplink shared channel in the cell C1 serving as the primary cell and an uplink control channel in the cell C2 serving as the secondary cell.

First, the transmitting power controller 304 calculates the transmitting power of an uplink shared channel (PUSCH) in the cell C1 serving as the primary cell (Sa1). Next, the transmitting power controller 304 calculates the transmitting power of an uplink control channel (PUCCH) in the cell C2 serving as the secondary cell (Sa2). Next, the transmitting power controller 304 judges whether the total transmitting power calculated in steps Sa1 and Sa2 is larger than maximum transmitting power P_{CMAX} (Sa3). Note that the maximum transmitting power P_{CMAX} is an upper limit value of the total transmitting power of the plurality of cells having undergone the carrier aggregation.

If it is judged in step Sa3 that the total is not larger than the maximum transmitting power P_{CMAX} (Sa3—No), the transmitting power values calculated in steps Sa1 and Sa2 are respectively set as a transmitting power value of the uplink shared channel and a transmitting power value of the uplink control channel.

In contrast, if it is judged in step Sa3 that the total is larger than the maximum transmitting power P_{CMAX} (Sa3—Yes), the transmitting power controller 304 judges whether the secondary cell is in the off state in the subframe that is a transmitting-power calculation target (Sa4). If it is judged that the secondary cell is in the off state (Sa4—Yes), the transmitting power controller 304 gives priority to the transmitting power of the uplink shared channel and reduces the transmitting power of the uplink control channel to obtain the total equal to or lower than the maximum transmitting power P_{CMAX} (Sa6).

For example, in a case where the transmitting power of the uplink shared channel calculated in step Sa1 is Ptx(Pcell PUSCH) and where the transmitting power of the uplink control channel calculated in step Sa2 is Ptx(Scell PUCCH), the transmitting power controller 304 determines a coefficient A (0<A≦1) satisfying Formula (1) and sets the transmitting power of the uplink control channel by multiplying Ptx(Scell PUCCH) by the coefficient A.

A·Ptx(Scell PUCCH)≦P_{CMAX}−Ptx(Pcell PUSCH) (1)

Note that P_{CMAX}, Ptx(Pcell PUSCH), and Ptx(Scell PUCCH) are linear values using, for example, watt [W] as a unit.

If it is judged in step Sa4 that the secondary cell is not in the off state (is in the on state) (Sa4—No), the transmitting power controller 304 gives priority to the transmitting power of the uplink control channel and reduces the transmitting power of the uplink shared channel to obtain the total equal to or lower than the maximum transmitting power P_{CMAX} (Sa5).

For example, the transmitting power controller 304 determines A satisfying Formula (2) and sets the transmitting power of the uplink shared channel by multiplying Ptx(Pcell PUSCH) by A.

A·Ptx(Pcell PUSCH)≦P_{CMAX}−Ptx(Scell PUCCH) (2)

As described above, if the secondary cell is in the off state, the transmitting power controller 304 assigns the transmitting power in such a manner as to give priority to the uplink shared channel of the primary cell over the uplink control channel of the secondary cell. If CSI regarding the downlink of the secondary cell has been transmitted through the uplink control channel of the secondary cell, the CSI might not be used until the downlink shared channel is transmitted after the secondary cell enters the on state or might not be used in such a case where the secondary cell enters the on state a long time later. Note that this embodiment assumes that a signal transmitted through a PUSCH is a data signal that does not include UCI (Uplink Control Information). However, the data signal may include UCI.

Accordingly, in such a case where CSI regarding the downlink of the secondary cell has been transmitted through the uplink control channel of the secondary cell, the transmitting power can be assigned to the uplink shared channel without being consumed by the information unlikely to be used. Accordingly, the transmitting power can be efficiently assigned.

### Second Embodiment

Hereinafter, a second embodiment of the invention will be described with reference to the drawings. The mobile communication system in this embodiment has the same configuration as that in the first embodiment. The mobile-station apparatus 13 in this embodiment also has the same configuration as that in the first embodiment, but the transmitting power controller 304 operates differently. Hereinafter, the transmitting power controller 304 will thus be described.

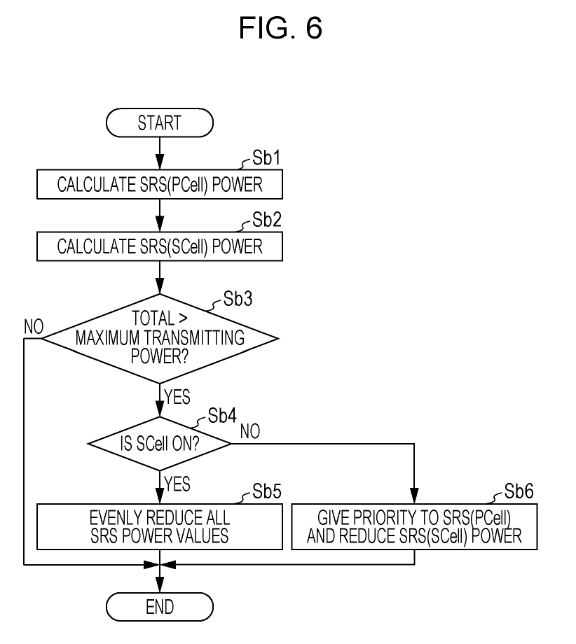

FIG. 6 is a flowchart explaining operation of the transmitting power controller 304. The flowchart in FIG. 6 illustrates a process performed at the time of controlling the transmitting power of subframes for respectively transmitting sounding reference signals in the cell C1 serving as the primary cell and in the cell C2 serving as the secondary cell.

First, the transmitting power controller 304 calculates the transmitting power of a sounding reference signal (SRS) in the cell C1 serving as the primary cell (Sb1). Next, the transmitting power controller 304 calculates the transmitting power of a sounding reference signal (SRS) in the cell C2 serving as the secondary cell (Sb2). Next, the transmitting power controller 304 judges whether the total transmitting power calculated in steps Sb1 and Sb2 is larger than the maximum transmitting power P_{CMAX} (Sb3).

If it is judged in steps Sb3 that the total is not larger than the maximum transmitting power P_{CMAX} (Sb3—No), the transmitting power value calculated in steps Sb1 and Sb2 are respectively set as transmitting power values of the sounding reference signals in the cells.

In contrast, if it is judged in step Sb3 that the total is larger than the maximum transmitting power P_{CMAX} (Sb3—Yes), the transmitting power controller 304 judges whether the secondary cell is in the off state in the subframe that is a transmitting-power calculation target (Sb4). If it is judged that the secondary cell is in the off state (Sb4—Yes), the transmitting power controller 304 gives priority to the transmitting power of the primary cell and reduces the transmitting power of the sounding reference signal in the secondary cell to obtain the total equal to or lower than the maximum transmitting power P_{CMAX} (Sb6).

For example, in a case where the transmitting power of the sounding reference signal in the primary cell calculated in step Sb1 is Ptx(Pcell SRS) and where the transmitting power of the sounding reference signal in the secondary cell calculated in step Sb2 is Ptx(Scell SRS), the transmitting power controller 304 determines a coefficient A (0<A≦1) satisfying Formula (3) and sets the transmitting power of the sounding reference signal in the secondary cell by multiplying Ptx(Scell SRS) by the coefficient A.

A·Ptx(Scell SRS)≦P_{CMAX}−Ptx(Pcell SRS) (3)

Note that Ptx(Pcell SRS) and Ptx(Scell SRS) are linear values using, for example, watt [W] as a unit.

If it is judged in step Sb4 that the secondary cell is not in the off state (is in the on state) (Sb4—No), the transmitting power controller 304 evenly reduces all of the transmitting power values of the sounding reference signals (Sb5).

For example, the transmitting power controller 304 determines A satisfying Formula (4) and sets the transmitting power of each sounding reference signal in the corresponding primary or secondary cell by multiplying corresponding Ptx(Pcell SRS) or Ptx(Scell SRS) by A.

A×(Ptx(Pcell SRS)+Ptx(Scell SRS))≦P_{CMAX} (4)

Note that if there are a plurality of secondary cells and if one or more of the secondary cells are in the off state, Formula (3′) below is used instead of Formula (3) where the total transmitting power of one or more sounding reference signals respectively for one or more of the secondary cells in the on state is Ptx(SCell_ON SRS) and where the total transmitting power of one or more sounding reference signals in the one or more secondary secondary cells in the off state is Ptx(SCell_OFF SRS).

A·Ptx(Scell_OFF SRS)≦P_{CMAX}−Ptx(Pcell SRS)−Ptx(Scell_ON SRS) (3′)

As described above, if the secondary cell is in the off state, the transmitting power controller 304 assigns the transmitting power in such a manner as to give priority to the sounding reference signal in the primary cell over the sounding reference signal in the secondary cell. The result of sounding reference signal measurement is also used when the uplink shared channel allocation is determined. However, since the uplink shared channel allocation is not performed in the secondary cell in the off state, the degree of importance of the result of sounding reference measurement performed in the secondary cell in the off state is lower than the degree of importance of the results of sounding reference measurement performed in the primary cell and the secondary cell in the on state.

Accordingly, the transmitting power can be assigned to the primary cell sounding reference of a higher degree of importance, and the transmitting power can thus be efficiently assigned. In addition, the sounding reference signal has been transmitted even if the secondary cell is in the off state. Accordingly, immediately after the state is switched to the on state, scheduling using the result of the sounding reference signal measurement can be performed.

### Third Embodiment

Hereinafter, a third embodiment of the invention will be described with reference to the drawings. The mobile communication system in this embodiment has the same configuration as that in the first embodiment. The mobile-station apparatus 13 in this embodiment also has the same configuration as in the first embodiment, but the transmitting power controller 304 operates differently. Hereinafter, the transmitting power controller 304 will thus be described.

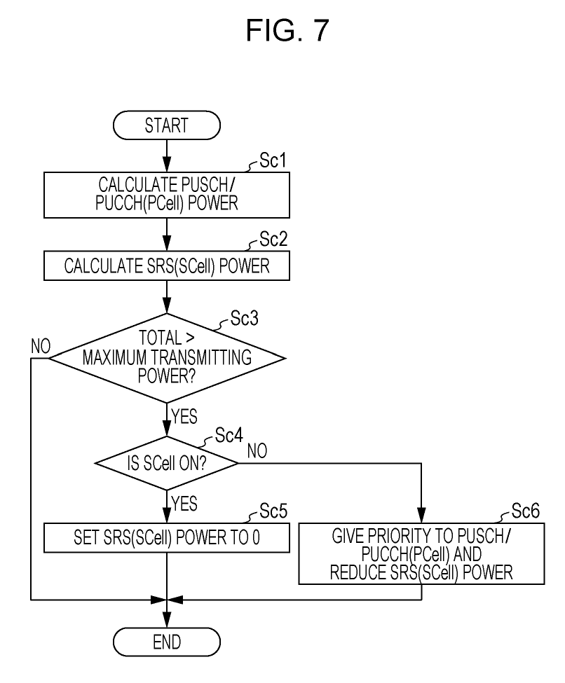

FIG. 7 is a flowchart explaining operation of the transmitting power controller 304. The flowchart in FIG. 7 illustrates a process performed at the time of controlling the transmitting power of subframes for respectively transmitting either an uplink shared channel or an uplink control channel in the cell C1 serving as the primary cell and a sounding reference signal in the cell C2 serving as the secondary cell.

First, the transmitting power controller 304 calculates the transmitting power of an uplink shared channel (PUSCH) or an uplink control channel (PUCCH) in the cell C1 serving as the primary cell (Sc1). Next, the transmitting power controller 304 calculates the transmitting power of a sounding reference signal (SRS) in the cell C2 serving as the secondary cell (Sc2). Next, the transmitting power controller 304 judges whether the total transmitting power calculated in steps Sc1 and Sc2 is larger than the maximum transmitting power P_{CMAX} (Sc3).

If it is judged in step Sc3 that the total is not larger than the maximum transmitting power P_{CMAX} (Sc3—No), the transmitting power values calculated in steps Sc1 and Sc2 are respectively set as transmitting power values of either the uplink shared channel (PUSCH) or the uplink control channel (PUCCH) and the sounding reference signal.

In contrast, if it is judged in step Sc3 that the total is larger than the maximum transmitting power P_{CMAX} (Sc3—Yes), the transmitting power controller 304 judges whether the secondary cell is in the off state in the subframe that is a transmitting-power calculation target (Sc4). If it is judged that the secondary cell is in the off state (Sc4—Yes), the transmitting power controller 304 gives priority to the transmitting power of the primary cell and reduces the transmitting power of the sounding reference signal in the secondary cell to obtain the total equal to or lower than the maximum transmitting power P_{CMAX} (Sc6).

For example, in a case where the transmitting power calculated in step Sc1, that is, the transmitting power of the uplink shared channel of the primary cell (PUSCH) or the uplink control channel (PUCCH) is Ptx(Pcell PUSCH/PUCCH) and where the transmitting power of the sounding reference signal in the secondary cell calculated in step Sc2 is Ptx(Scell SRS), the transmitting power controller 304 determines a coefficient A (0<A≦1) satisfying Formula (5) and sets the transmitting power of the sounding reference signal in the secondary cell by multiplying Ptx(Scell SRS) by the coefficient A.

A·Ptx(Scell SRS)≦P_{CMAX}−Ptx(Pcell PUSCH/PUCCH) (5)

Note that Ptx(Pcell PUSCH/PUCCH) is a linear value using, for example, watt [W] as a unit.

If it is judged in step Sc4 that the secondary cell is not in the off state (is in the on state) (Sc4—No), the transmitting power controller 304 sets the transmitting power of the sounding reference signal in the secondary cell to 0 (Sc5). That is, the mobile-station apparatus 13 does not transmit the sounding reference signal in the secondary cell.

As described above, if the secondary cell is in the off state, the transmitting power controller 304 transmits the sounding reference signal in the secondary cell within a range not exceeding the maximum transmitting power when the uplink shared channel or the uplink control channel is also transmitted in the primary cell. Note that in this embodiment, a signal transmitted through the PUSCH may be a data signal that does not include UCI (Uplink Control Information), but the data signal may include the UCI.

Although FIG. 1 illustrates only one small-base-station apparatus that is the small-base-station apparatus 12, there is an arrangement method referred to as cluster arrangement in which a plurality of small-base-station apparatuses using the same frequency band are arranged. In the cluster arrangement, reception levels of the sounding reference signals are measured in the small-base-station apparatuses. An apparatus that manages these small-base-station apparatuses can individually determine that the small-base-station apparatuses are to be in the on or off state on the basis of the results of the measurement. Accordingly, even if one of the secondary cells is in the off state, the sounding reference signal in the secondary cell is transmitted within the range not exceeding the maximum transmitting power. Accordingly, the number of mobile-station apparatuses located in the communication range of the small-base-station apparatuses can be grasped, and whether to cause the individual small-base-station apparatuses to be in the on or off state can be determined more appropriately.

### Modification of Third Embodiment

In the third embodiment, if the secondary cell is in the off state, a sounding reference signal in the secondary cell is transmitted within the range not exceeding the maximum transmitting power when the uplink shared channel or the uplink control channel is also transmitted in the primary cell. However, if the transmitting power is low when being set not to exceed the maximum transmitting power, a result of measurement performed on the small-base-station apparatus has a too large error. Hence, in this modification, if the coefficient A in step Sc6 is not equal to or not larger than a threshold set in advance, the transmitting power of the sounding reference signal is set to 0.

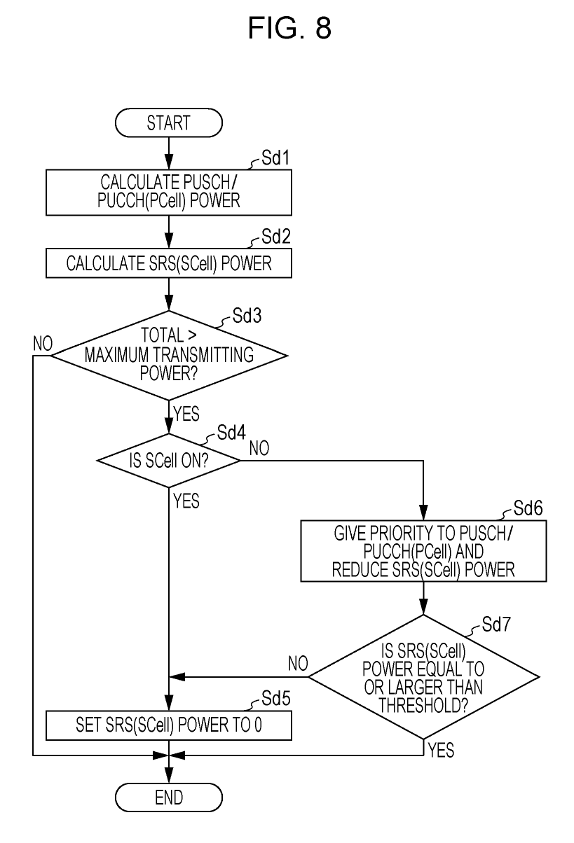

FIG. 8 is a flowchart explaining operation of the transmitting power controller 304. Like FIG. 7, the flowchart in FIG. 8 illustrates a process performed at the time of controlling the transmitting power of subframes for respectively transmitting either an uplink shared channel or an uplink control channel in the cell C1 serving as the primary cell and a sounding reference signal in the cell C2 serving as the secondary cell. The flowchart in FIG. 8 is different from FIG. 7 in that step Sd7 is provided after step Sc6. The other steps Sc1 to Sc6 are the same as those in FIG. 7.

In step Sd7, the transmitting power controller 304 judges whether the coefficient A calculated in step Sc6 is equal to or larger than a threshold set in advance (for example, 0.95). If it is judged that the coefficient A is equal to or larger than the threshold (Sd7—Yes), the transmitting power controller 304 uses the transmitting power calculated in step Sc6. In contrast, if it is judged that the coefficient A is not equal to or not larger than the threshold (Sd7—No), the transmitting power controller 304 proceeds to step Sc5 and sets the transmitting power of the sounding reference signal in the secondary cell to 0. That is, the mobile-station apparatus 13 does not transmit the sounding reference signal in the secondary cell. Note that in this modification, the signal transmitted through the PUSCH may be a data signal that does not include UCI (Uplink Control Information), but the data signal may include the UCI.

As described above, in this modification, if the secondary cell is in the off state, and if the total transmitting power is set equal to or lower than the maximum transmitting power, but if the coefficient A for the sounding reference signal in the secondary cell is smaller than the threshold, that is, if reduction percentage is larger than a predetermined percentage, the sounding reference signal in the secondary cell is not transmitted.

This can prevent a high reduction percentage from causing a large error included in a path loss estimated from a result of measurement of the sounding reference signal.

### Fourth Embodiment

Hereinafter, a fourth embodiment of the invention will be described with reference to the drawings. The mobile communication system in this embodiment has the same configuration as that in the first embodiment. The mobile-station apparatus 13 in this embodiment also has the same configuration as in the first embodiment, but the transmitting power controller 304 operates differently. Hereinafter, the transmitting power controller 304 will thus be described.

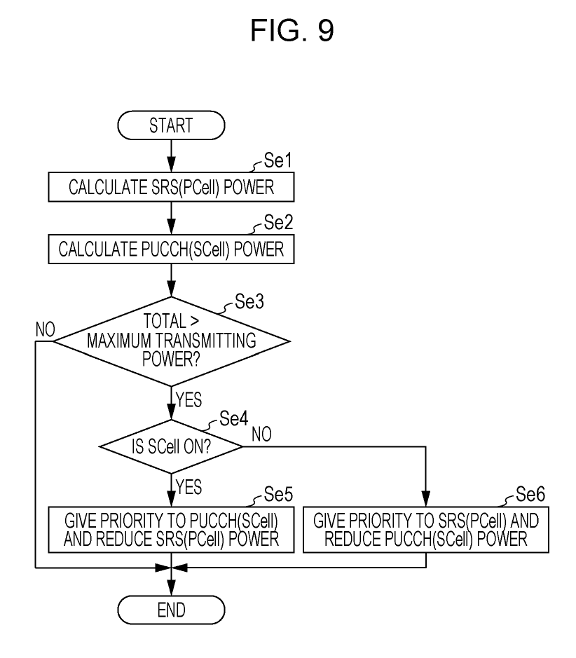

FIG. 9 is a flowchart explaining operation of the transmitting power controller 304. The flowchart in FIG. 9 illustrates a process performed at the time of controlling the transmitting power of subframes for respectively transmitting a sounding reference signal (SRS) in the cell C1 serving as the primary cell and an uplink control channel (PUCCH) in the cell C2 serving as the secondary cell.

First, the transmitting power controller 304 calculates the transmitting power of a sounding reference signal (SRS) in the cell C1 serving as the primary cell (Se1). Next, the transmitting power controller 304 calculates the transmitting power of an uplink control channel (PUCCH) in the cell C2 serving as the secondary cell (Se2). Next, the transmitting power controller 304 judges whether the total transmitting power calculated in steps Se1 and Se2 is larger than the maximum transmitting power P_{CMAX} (Se3).

If it is judged in step Se3 that the total is not larger than the maximum transmitting power P_{CMAX} (Se3—No), the transmitting power values calculated in steps Se1 and Se2 are respectively set as transmitting power values of the sounding reference signal and uplink control channel (PUCCH).

In contrast, if it is judged in step Se3 that the total is larger than the maximum transmitting power P_{CMAX} (Se3—Yes), the transmitting power controller 304 judges whether the secondary cell is in the off state in the subframe that is a transmitting-power calculation target (Se4). If it is judged that the secondary cell is in the off state (Se4—Yes), the transmitting power controller 304 gives priority to the transmitting power of the primary cell and reduces the transmitting power of the uplink control channel in the secondary cell to obtain the total equal to or smaller than the maximum transmitting power P_{CMAX} (Se6).

For example, in a case where the transmitting power of the sounding reference signal in the primary cell (SRS) calculated in step Set is Ptx(Pcell SRS) and where the transmitting power of the uplink control channel in the secondary cell calculated in step Se2 is Ptx(Scell PUCCH), the transmitting power controller 304 determines a coefficient A (0<A≦1) satisfying Formula (6) and sets the transmitting power of the sounding reference signal in the secondary cell by multiplying Ptx(Scell PUCCH) by the coefficient A.

A·Ptx(Scell PUCCH)≦P_{CMAX}−Ptx(Pcell SRS) (6)

If it is judged in step Se4 that the secondary cell is not in the off state (is in the on state) (Se4—No), the transmitting power controller 304 sets the transmitting power of the sounding reference signal in the primary cell to 0 (Se5). That is, the mobile-station apparatus 13 does not transmit the sounding reference signal in the primary cell.

As described above, if the secondary cell is in the off state, the transmitting power controller 304 transmits the uplink control channel for the secondary cell within the range not exceeding the maximum transmitting power when the sounding reference signal is also transmitted in the primary cell. If CSI regarding the downlink of the secondary cell has been transmitted through the uplink control channel of the secondary cell, the CSI might not be used until the downlink shared channel is transmitted after the secondary cell enters the on state or might not be used in such a case where the secondary cell enters the on state a long time later.

Accordingly, in such a case where CSI regarding the downlink of the secondary cell has been transmitted through the uplink control channel of the secondary cell, the transmitting power can be assigned to the uplink shared channel without being consumed by the information unlikely to be used. Accordingly, the transmitting power can be efficiently assigned.

Note that in the description of the aforementioned embodiments, the cell C1 is formed by the macro-base-station apparatus 11, but the base-station apparatus forming the cell C1 may be a small-base-station apparatus having a smaller communication range than that of the macro-base-station apparatus.

In the aforementioned embodiments, the entire communication range of the cell C2 is included in the communication range of the cell C1. However, the communication range of the cell C2 is not limited thereto and may be partially included in the communication range of the cell C1.

In the description of the aforementioned embodiments, switching between the on and off states is performed in only the secondary cell but may be performed in the primary cell.

In the aforementioned embodiments, the transmitting power controller 304 refers to whether the secondary cell is in the off state and thereby determines the transmitting power. However, if off state timing can be grasped in advance, the state of the secondary cell exhibited in a subframe a predetermined number of subframes before the subframe exhibiting the off state may be considered to be equivalent to the off state. On the contrary, if on state timing can be grasped in advance, the state of the secondary cell exhibited in a subframe a predetermined number of subframes before the subframe exhibiting the on state may be considered to be equivalent to the on state.

In addition, a program for implementing the functions of the macro-base-station apparatus 11, the small-base-station apparatus 12, and the mobile-station apparatus 13 in FIG. 1 may be recorded in a computer readable medium. The apparatuses may be implemented by causing a computer system to read and run the program recorded in the medium. Note that the “computer system” herein includes an OS and hardware such as peripheral devices.

The “computer readable recording medium” refers to a flexible disk, a magneto-optical disk, a portable medium such as a ROM or a CD-ROM, or a memory device such as a hard disk incorporated in the computer system. Further, the “computer readable recording medium” includes a medium that dynamically holds the program for a short time, such as a communication line used in a case where the program is transmitted through a network such as the Internet or through a communication line such as a telephone line, and also includes a medium that holds the program for a predetermined period of time, such as a volatile memory in the computer system serving as a server or a client in the case of the transmission. The program may be a program for implementing some of the functions described above and further, may be a program that can implement the functions by combining the program with a program already recorded in the computer system. Note that the invention in the present application is not limited to the aforementioned embodiments. In the embodiments, the mobile-station apparatus 13 has been described as an example of a terminal apparatus or a communication apparatus. However, the invention in the present application is not limited thereto. It goes without saying that the invention is applicable to a terminal apparatus or a communication apparatus of a fixed-type or unmovable electronic device installed outdoor or indoor, such as AV equipment, kitchen equipment, a cleaner or a washing machine, air-conditioning equipment, office equipment, a vending machine, or other household equipment.

The functional blocks of the macro-base-station apparatus 11, the small-base-station apparatus 12, and the mobile-station apparatus 13 that are described above with reference to FIG. 1 may be individually implemented as chips or may be partially or entirely integrated into a chip. An integrated circuit method is not limited to LSI, and the functional blocks may be implemented by a dedicated circuit or a general-purpose processor. Any of a hybrid or a monolithic may be used. Some of the functions may be implemented by hardware, and the others may be implemented by software.

In a case where the progress of semiconductor technology leads to a technology replacing LSI, an integrated circuit using the technology is also usable.

The embodiments of the invention have heretofore been described with reference to the drawings, but the specific configuration of the invention is not limited to the embodiments. A modification in designing and the like may be made without departing from the spirit of the invention.

This international application claims the benefit of Japanese Patent Application No. 2014-120935, filed Jun. 11, 2014, which is hereby incorporated by reference herein in its entirety.

### REFERENCE SIGNS LIST

11 macro-base-station apparatus
12 small-base-station apparatus
13 mobile-station apparatus
301 PUSCH generator
302 PUCCH generator
303 SRS generator
304 transmitting power controller
305 scheduler
306 mapper
307 transmitter
308 antenna unit
309 receiver
310 demapper
311 data signal processor
312 control signal processor

1. A terminal apparatus that is connected to a plurality of cells simultaneously and that performs communication by using the plurality of cells, the terminal apparatus comprising:
a control signal processor that receives a control signal providing a notification indicating that at least one of the plurality of cells is to enter an off state in which data communication is not performed temporarily; and
a transmitting power controller that, in a case where transmitting power of each of the plurality of connected cells is determined and in a case where a value of a total of the transmitting power needed for the plurality of cells is judged to exceed maximum transmitting power of the terminal apparatus, refers to content of the notification provided by the control signal and judges priority in assigning transmitting power to a channel and a signal that are transmitted in each of the plurality of connected cells,
wherein the transmitting power controller gives the priority in assigning power to a sounding reference signal to be transmitted in at least one of the cells that is not in the off state over a sounding reference signal to be transmitted in the one cell in the off state.

2. The terminal apparatus according to claim 1,
wherein the transmitting power controller gives the priority in assigning the power to the sounding reference signal to be transmitted in the cell not in the off state over a control channel to be transmitted in the one cell in the off state.

3. The terminal apparatus according to claim 1,
wherein the transmitting power controller gives the priority in assigning the power to a shared channel or a control channel to be transmitted in the cell not in the off state over to the sounding reference signal to be transmitted in the one cell in the off state.

4. The terminal apparatus according to claim 1,
wherein the control signal processor receives the control signal from the cell not in the off state, the control signal providing the notification indicating that the at least one cell is to enter the off state in which the data communication is not performed temporarily.

5. The terminal apparatus according to claim 1,
wherein the notification received by the control signal processor includes at least one of pieces of information regarding a transmission cycle, a used resource element, an antenna port, a signal sequence, and a cell ID used for signal generation, the notification indicating that the at least one cell is to enter the off state in which the data communication is not performed temporarily.
